(19) United States
(12) Patent Application Publication
(10) Pub. No.: US 2016/0121472 A1
(43) Pub. Date: May 5, 2016

(54) METHOD FOR CONTROLLING THE IMPACT ENERGY OF AN IMPULSE PISTON OF A PERCUSSION TOOL

(71) Applicant: MONTABERT, Saint-Priest (FR)

(72) Inventor: Jean-Sylvain COMARMOND, Vourles (FR)

(73) Assignee: MONTABERT, Saint-Priest (FR)

(21) Appl. No.: 14/890,385

(22) PCT Filed: May 22, 2014
(86) PCT No.: PCT/EP2014/060572

§ 371 Date: Nov. 10, 2015

(30) Foreign Application Priority Data
Jun. 12, 2013 (FR) 13/55418

(51) Int. Cl. B25D 9/26; E02F 9/24; E02F 9/20; E02F 5/32

(52) U.S. Cl. CPC B25D 9/26; E02F 5/323; E02F 9/245; E02F 9/20

(57) ABSTRACT

This control method comprises the steps consisting in providing a control device (16) arranged for adjusting the impact energy of the striking piston (4) of a percussion apparatus (2), providing a controller (17) arranged for applying a control instruction to the control device (16), switching on the percussion apparatus (2), measuring at least one seismic datum in the vicinity of a structure to be protected (13), and transmitting the at least one seismic datum measured at the controller (17), comparing the at least one seismic datum received by the controller (17) with a predetermined threshold value, correcting the control instruction of the control device (16) according to the at least one received seismic datum, and applying, by means of the controller (17), said corrected control instruction to the control device (16).

### FIELD

The present disclosure relates to a method for controlling the impact energy of a striking piston of a percussion apparatus actuated by a pressurized incompressible fluid, and an assembly for implementing this method.

### BACKGROUND

A percussion apparatus, called hydraulic rock breaker, is commonly used for various applications, such as breaking blocks in a quarry, demolition work or even digging trenches. A hydraulic rock breaker includes in particular a striking piston arranged for cyclically hitting a tool such as to produce an impact energy on the material to be demolished. During the use of a rock breaker, the latter hence produces a succession of shock waves on the material to be demolished, these shock waves are propagated in the ground around the rock breaker and act as seismic waves.

When a rock breaker is used in the vicinity of a building, a block of flats, a tunnel or any other vulnerable structure, the seismic waves generated by the rock breaker are liable to damage these vulnerable structures.

Thus, in order to preserve the integrity of vulnerable structures, the use of a rock breaker may be limited, prohibited even, below a minimum distance from these vulnerable structures. Furthermore, the choice of rock breaker model may be conditioned by the type of work to be carried out. For example, when the work must be achieved in the vicinity of vulnerable structures, it may be necessary to select a rock breaker having an impact energy which is sufficiently weak so as not to risk damaging these vulnerable structures.

Generally, during the carrying out of these works in the vicinity of vulnerable structures, the levels of the seismic speeds of the seismic waves which propagate along these vulnerable structures are recorded throughout the work, thanks to the use of a detecting system comprising in particular one or several geophones and a recorder arranged for verifying the seismic speed levels measured by the geophone(s).

When this work is carried out using a rock breaker, the levels of seismic speeds measured on the structures in the vicinity may depend on the nature of the ground between the rock breaker and these structures, but also on the value of energy produced with each impact by the rock breaker. This energy is generally approximately constant for a given rock breaker, however, the nature of the ground between the rock breaker and the structures, may vary very rapidly and thus transmit in a non constant manner the seismic waves between the rock breaker tool and the vulnerable structure.

In these conditions, the variability of this seismic wave transmission makes the use of rock breaker particularly tricky. In order to overcome this issue, it is common that a project supervisor is forced to use a rock breaker of very low energy, the execution speed of the work is thereby slow, and the work cost becomes more important.

In other cases, the detecting system positioned on the structure to be protected may further comprise an emitter arranged for transmitting a warning signal to the operator of the rock breaker so as to warn him of the exceedance of the maximum allowed level of seismic speeds, the rock breaker operator must therefore change the operating position of the rock breaker thereof or replace it by a model of rock breaker which has less energy.

In all cases, the use of a rock breaker in the vicinity of vulnerable structures is a consequence of human error, and the maximum level of seismic speeds is often exceeded.

The present disclosure aims to remedy to these drawbacks.

### SUMMARY

The technical issue at the basis of the disclosure hence relates to providing a control method and an assembly for the implementation thereof, allowing to preserve the integrity of vulnerable structures during the carrying out of the work using a percussion apparatus, while limiting the production costs of this work.

To this end, the present disclosure relates to a control method for controlling the impact energy of a striking piston of a percussion apparatus actuated by a pressurized incompressible fluid, characterized in that it comprises the following steps:

providing a control device arranged for adjusting the impact energy of the striking piston,
providing a controller arranged for applying a control instruction to the control device,
switching on the percussion apparatus,
measuring at least one seismic datum in the vicinity of a structure to be protected, and for example on such a structure,
transmitting the at least one seismic datum measured to the controller,
comparing the at least one seismic datum received by the controller with a predetermined threshold value,
correcting the control instruction of the control device depending on the at least one received seismic datum, and
applying, by means of the controller, said corrected control instruction to the control device.

Thus, the control method according to the disclosure allows automatically adjusting, via the controller and the control device, the impact energy of the striking piston of the seismic data measured in the vicinity of the structure to be protected. These dispositions allow optimizing the operation of the percussion apparatus, while preventing the seismic speeds of the seismic waves generated by the percussion apparatus from exceeding the predetermined threshold value. It thereby results an optimal protection of the vulnerable structures in the vicinity of the percussion apparatus during the use thereof.

According to an implementation embodiment of the control method, the control instruction is corrected such that the impact energy of the striking piston adjusted by the control device induces seismic data lower than the predetermined threshold value.

According to an implementation embodiment of the control method, the control instruction is corrected by taking into account the predetermined threshold value.

According to an implementation embodiment of the control method, the latter comprises a step of iteratively repeating the steps of measuring, transmitting, comparing, correcting and applying.

According to an implementation embodiment of the control method, the latter comprises a step of adjusting, in particular by an operator entry, the predetermined threshold value. These dispositions allow adapting the predetermined threshold value according to the structure to be protected.

According to an implementation embodiment of the control method, if the at least one seismic datum is higher than the predetermined threshold value, the correcting step includes correcting the control instruction of the control device such as to reduce the impact energy of the striking piston.

According to an implementation embodiment of the control method, if the at least one seismic datum received is lower than the predetermined threshold value, the correcting step includes correcting the control instruction of the control device such as to increase the impact energy of the striking piston.

According to an implementation embodiment of the control method, if the at least one seismic datum received is lower than the predetermined threshold value and if the difference between the at least one seismic datum received and the predetermined threshold value is higher than a predetermined limiting value, the correcting step includes correcting the control instruction of the control device such as to increase the impact energy of the striking piston.

According to an implementation embodiment of the control method, if the at least one seismic datum received is lower than the predetermined threshold value and if the difference between the at least one received seismic datum and the predetermined threshold value is lower than the predetermined limiting value, the correcting step maintains the value of the control instruction applied beforehand.

According to an implementation embodiment, the control method comprises a step of interrupting the supply of the percussion apparatus in pressurized incompressible fluid when the at least one seismic datum received by the controller is higher than the predetermined threshold value and when simultaneously the impact energy of the striking piston is adjusted to its minimum by the control device. These dispositions allow automatically interrupting the supply in pressurized incompressible fluid of the percussion apparatus so as to protect the vulnerable structure from the seismic waves produced by the percussion apparatus. In such a case, the operator must move the percussion apparatus away from the vulnerable structure before switching said percussion apparatus on again.

According to an implementation embodiment of the disclosure, the measuring step measures the seismic speed of the seismic waves which propagate in the vicinity of the structure to be protected.

According to an implementation embodiment of the disclosure, the measuring step is achieved with one or several geophones disposed in the vicinity of the structure to be protected.

According to an implementation embodiment, the control method comprises a step of displacing a control member included by the control device between a first control position corresponding to maximum impact energy of the striking piston and a second control position corresponding to minimum impact energy of the striking piston.

According to an implementation embodiment of the control method, the control instruction initially applied to the control device, that is to say, the switching on of the percussion apparatus, is determined such as to adjust the impact energy of the striking piston to a minimum value.

According to an implementation embodiment of the control method, the step of displacing the control member is achieved in a continuous manner or in stages.

The present disclosure further relates to an assembly comprising:
a percussion apparatus actuated by a pressurized incompressible fluid, including a striking piston arranged for hitting a tool during each operating cycle of the percussion apparatus,
a control device arranged for adjusting the impact energy of the striking piston,
a controller arranged for applying a control instruction to the control device,
seismic data measuring means intended to be disposed in the vicinity of a structure to be protected,
transmission means connected to the seismic data measuring means, and arranged for transmitting the seismic data measured by the measuring means,

the controller being arranged for:
receiving the seismic data transmitted by the transmission means,
comparing the seismic data received with a predetermined threshold value,
correcting the control instruction of the control device based on the received seismic data, and
applying said corrected control instruction to the control device.

According to one embodiment of the disclosure, the controller is arranged for correcting the control instruction such that the impact energy of the striking piston adjusted by the control device induces seismic data lower than the predetermined threshold value.

According to an embodiment of the disclosure, when the seismic data received by the controller are higher than the predetermined threshold value, the controller is arranged for correcting the control instruction of the control device such as to decrease the impact energy of the striking piston.

According to one embodiment of the disclosure, when the seismic data received by the controller is lower than the predetermined threshold value, the controller is arranged for correcting the control instruction of the control device such as to increase the impact energy of the striking piston.

According to one embodiment of the disclosure, when the seismic data received by the controller are lower than the predetermined threshold value and when simultaneously the difference between the received seismic data and the predetermined threshold value is higher than a predetermined limiting value, the controller is arranged for correcting the control instruction of the control device such as to increase the impact energy of the striking piston.

According to one embodiment of the disclosure, the assembly comprises a high pressure supply circuit intended for supplying the percussion apparatus with pressurized incompressible fluid, and a low pressure return circuit.

According to one embodiment of the disclosure, the percussion apparatus comprises a body delimiting a cylinder in which the striking piston is displaceably mounted in an alternative manner.

For example, the striking piston and the cylinder delimit at least one low pressure chamber permanently connected to the high pressure supply circuit and a high pressure chamber alternatively connected with the high pressure supply circuit and the low pressure return circuit.

According to a feature of the disclosure, the controller is arranged for controlling the interruption of the supply of the percussion apparatus in pressurized incompressible fluid when the seismic data received by the controller are higher than the predetermined threshold value and when simultaneously the impact energy of the striking piston is adjusted to its minimum by the control device.

According to one embodiment of the disclosure, the assembly comprises a blocking device arranged for blocking the high pressure supply circuit.

According to one embodiment of the disclosure, the blocking device is mounted on the high pressure supply circuit.

According to one embodiment of the disclosure, the blocking device comprises a blocking member displaceable between a blocking position in which said blocking member blocks the high pressure supply circuit, and a releasing position in which said blocking member releases the high pressure supply circuit.

According to one embodiment of the disclosure, the controller is arranged for controlling the displacement of the blocking member between the blocking and releasing positions thereof.

According to one embodiment of the disclosure, the blocking device comprises an actuating element arranged for displacing the blocking member between the blocking and releasing positions thereof.

According to one embodiment of the disclosure, the actuating element is arranged for receiving a control instruction coming from the controller, and for displacing the blocking member according to the control instruction.

According to one embodiment of the disclosure, the blocking device is a solenoid valve, and for example an on-off control solenoid valve, such as a normally open solenoid valve, or a normally closed solenoid valve.

According to one embodiment of the disclosure, the measuring means are arranged for measuring the seismic speeds of the seismic waves propagating in the vicinity of the structure to be protected.

According to a feature of the disclosure, the measuring means include one or several geophones intended to be disposed in the vicinity of the structure to be protected.

According to a feature of the disclosure, the control device comprises a control member displaceable between a first control position corresponding to maximum impact energy of the striking piston and a second control position corresponding to minimum impact energy of the striking piston.

According to one embodiment of the disclosure, the control device is external to the percussion apparatus.

According to one embodiment of the disclosure, the control device is hydraulic.

According to one embodiment of the disclosure, the controller is arranged for controlling the displacement of the control member between the first and second positions thereof, and for example in a continuous manner or in stages.

According to one embodiment of the disclosure, the control device is provided with an actuating member arranged for displacing the control member between the first and second control positions thereof.

According to one embodiment of the disclosure, the actuating member is arranged for receiving the corrected control instruction coming from the controller, and for displacing the control member according to the corrected control instruction.

According to one embodiment of the disclosure, the control device comprises a solenoid valve, and for example a proportional solenoid valve.

According to a feature of the disclosure, the control device is arranged for adjusting the striking stroke of the striking piston between a short striking stroke and a long striking stroke.

According to one embodiment of the disclosure, the control device is arranged for adjusting in a continuous manner or in stages the striking stroke of the striking piston between the short and long striking strokes thereof.

According to one embodiment of the disclosure, the control device is arranged for applying a hydraulic control instruction to a control circuit provided on the percussion apparatus, the hydraulic control instruction being determined based on the corrected control instruction. The control circuit comprises for example a striking stroke adjusting device arranged for adjusting the striking stroke of the striking piston between the short and long striking strokes thereof.

According to one embodiment of the disclosure, the controller is arranged for correcting the control instruction of the control device such as to decrease the striking stroke of the striking piston when the seismic data received by the controller are higher than the predetermined threshold value.

According to one embodiment of the disclosure, the controller is arranged for correcting the control instruction of the control device such as to increase the striking stroke of the striking piston when the seismic data received by the controller are lower than the predetermined threshold value.

According to one embodiment of the disclosure, the assembly comprises a supply line fluidly connected on the one hand to the high pressure supply circuit and on the other hand to the control device, and a return line fluidly connected on the one hand to a low pressure tank and on the other hand to the control device, and a control line fluidly connected on the one hand to the percussion apparatus and on the other hand to the control device, the control line being arranged to be fluidly connected to the return line and/or the supply line according to the position of the control member.

According to one embodiment of the disclosure, the control line is fluidly connected to the control circuit belonging to the percussion apparatus.

According to one embodiment of the disclosure, the supply, return and control lines open into a cylinder in which the control member is slidably mounted.

According to one embodiment of the disclosure, the supply line is provided with a nozzle.

According to a feature of the disclosure, the control device comprises a pressure regulator, and for example a proportional control pressure regulator.

According to a feature of the disclosure, the control device is arranged for adjusting the operating pressure of the percussion apparatus between a minimum operating pressure and a maximum operating pressure.

According to one embodiment of the disclosure, the control device is arranged for adjusting in a continuous manner or in stages, the operating pressure of the percussion apparatus between the minimum and maximum operating pressures.

According to one embodiment of the disclosure, the control device is mounted on the high pressure supply circuit, and is arranged for adjusting the pressure of the incompressible fluid flowing in the high pressure supply circuit.

According to one embodiment of the disclosure, the controller is arranged for correcting the control instruction of the control device such as to decrease the operating pressure of the percussion apparatus when the seismic data received by the controller are higher than the predetermined threshold value.

According to one embodiment of the disclosure, the controller is arranged for correcting the control instruction of the control device such as to increase the operating pressure of the percussion apparatus when the seismic data received by the controller are lower than the predetermined threshold value.

According to one embodiment of the disclosure, the controller and the percussion apparatus are intended to be mounted on a carrying machine, such as a hydraulic excavator.

According to one embodiment of the disclosure, the controller includes a receptor arranged for receiving the seismic data transmitted by the transmission means.

### BRIEF DESCRIPTION OF THE DRAWINGS

The disclosure will be better understood by means of the following description with reference to the accompanying schematic drawing representing, by way of non-limiting examples, three embodiments of this assembly.

FIG. 1 is a schematic view of an assembly according to a first embodiment of the disclosure.

FIG. 2 is a schematic view of an assembly according to a second embodiment of the disclosure.

FIG. 3 is a schematic view of an assembly according to a third embodiment of the disclosure.

### DETAILED DESCRIPTION OF THE DRAWINGS

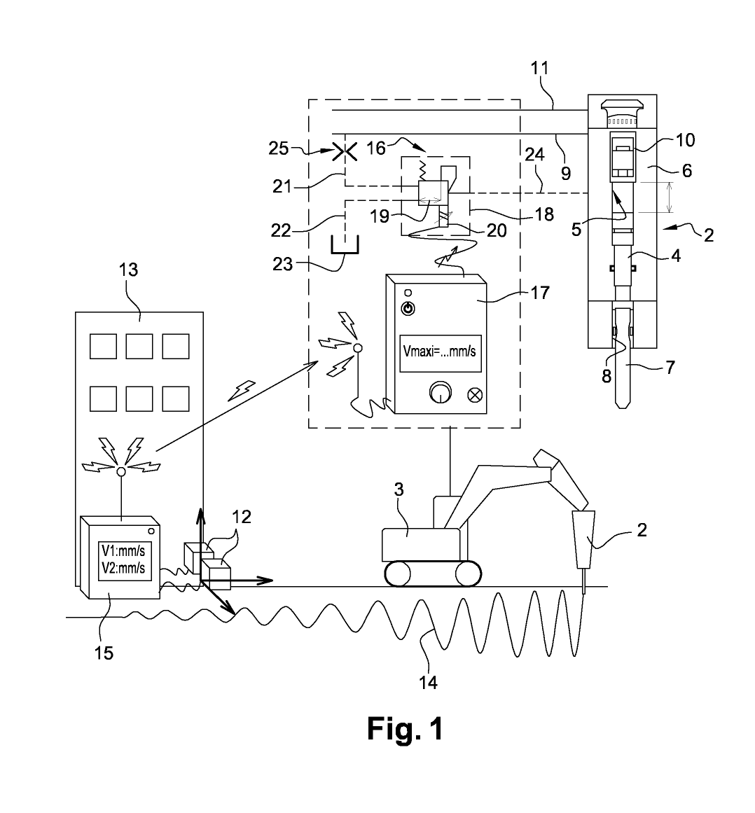

FIG. 1 represents an assembly according to a first embodiment of the disclosure comprising a percussion apparatus 2, such as a hydraulic rock breaker, mounted on a carrying machine 3, such as a hydraulic excavator.

The percussion apparatus 2 comprises a staged striking piston 4 slidably mounted in an alternative manner inside a cylinder 5 arranged in a body 6 of the percussion apparatus 2. During each operating cycle of the percussion apparatus 2, the striking piston 4 hits the upper end of a tool 7 slidably mounted in a bore 8 arranged in the body 3 coaxially to the cylinder 5. The striking piston 4 and the cylinder 5 delimit for example a low pressure chamber (not represented on the figures) permanently fluidly connected to a high pressure supply circuit 9 intended for supplying the percussion apparatus 2 with pressurized incompressible fluid, and a high pressure chamber (not represented on the figures) of a more important section arranged over the striking piston 4.

The percussion apparatus 2 further comprises a dispenser 10 mounted in the body 6 and arranged for allowing the high pressure chamber to be put in alternative connection with the high pressure supply circuit 9, during the striking stroke of the striking piston 4, and with a low pressure return circuit 11 during the upstroke of the striking piston 4.

The assembly further comprises one or several geophones 12 intended to be disposed in the vicinity of a structure to be protected 13 such as to measure seismic data, such as seismic speeds, pertaining to seismic waves 14 propagating in the vicinity of the structure 13 and caused by the operating of the percussion apparatus 2.

The assembly also comprises an emitter 15 connected to the geophones 12, and arranged for transmitting the seismic data measured by the geophones 12. The emitter 15 is preferably disposed in the vicinity of the geophones 12, and thereby of the structure to be protected 13.

In addition, the assembly comprises a hydraulic control device 16 external to the percussion apparatus 2 and arranged for adjusting the impact energy of the striking piston 4, and a controller 17 arranged for applying a control instruction to the control device 16.

According to the embodiment represented on FIG. 1, the control device 16 is formed by a proportional solenoid valve 18.

The proportional solenoid valve 18 comprises a control member 19 displaceable between a first control position corresponding to maximum impact energy of the striking piston 4 and a second control position corresponding to minimum impact energy of the striking piston 4. The proportional solenoid valve 18 further comprises an actuating spool 20 arranged for receiving the control instruction coming from the controller 17, and for displacing the control member 19 between the first and second control positions thereof according to the received control instruction.

The assembly further comprises a supply line 21 fluidly connected on the one hand to the high pressure supply circuit 9 and on the other hand to the solenoid valve 18, and a return line 22 fluidly connected on the one hand to a low pressure tank 23 and on the other hand to the solenoid valve 18, and a control line 24 fluidly connected on the one hand to the percussion apparatus 2 and on the other hand to the solenoid valve 18. The supply 21, return 22 and control 24 lines advantageously open into a cylinder (not represented on the figures) in which the control member 19 is slidably mounted, and the supply line 21 is preferably provided with a nozzle 25.

The control line 24 is arranged to be fluidly connected to the return line 22 and/or the supply line 21 according to the position of the control member 19, and thereby according to the control instruction applied to the solenoid valve 18 by the controller 17.

According to the embodiment represented on FIG. 1, the control device 16 is arranged for adjusting the striking stroke of the striking piston 4 between a short striking stroke and a long striking stroke, and thus according to the pressure of the fluid flowing in the control line 24. The control device 16 may for example be arranged for applying, via the control line 24, a hydraulic control instruction to a control circuit provided on the percussion apparatus 2 and arranged for modifying the striking stroke of the striking piston 4, the hydraulic control instruction thus being determined according to the control instruction applied to the control device 16. Such a control circuit may for example be similar to the control circuit described in document FR 2 375 008.

The controller 17 is arranged for:
receiving the seismic data transmitted by the emitter 15.
comparing the received seismic data with a predetermined threshold value,
correcting the control instruction of the control device 16 according to the received seismic data, and
applying the corrected control instruction to the control device 16 such as to adjust the impact energy of the striking piston 4.

The controller 17 is more particularly arranged for:
correcting the control instruction of the control device 16 such as to decrease the striking stroke of the striking piston 4 when the seismic data received by the controller 17 are higher than the predetermined threshold value, and
correcting the control instruction of the control device 16 such as to increase the striking stroke of the striking piston 4 when the seismic data received by the controller 17 are lower than the predetermined threshold value.
Thus, when the percussion apparatus 2 is in operation, the speed values, or the maximum of these speed values, of the seismic waves 14 generated by the percussion apparatus 2 and propagating in the vicinity of the structure 13 are measured by the geophones 12 and are transmitted by the emitter 15 to the controller 17. These values are thus compared with the predetermined threshold value. When these values exceed the predetermined threshold value, then the controller 17 applies a control instruction to the control device 16 such as to decrease the striking stroke of the striking piston 4, and hence such as to decrease the impact energy of the striking piston 4, in order to preserve the integrity of the structure 13. On the other hand, when these values are lower than the predetermined threshold value, then the controller 17 applies a control instruction to the control device 16 such as to increase the striking stroke of the striking piston 4, and hence such as to increase the impact energy of the striking piston 4, and thus to optimize the operating of the percussion apparatus 2.

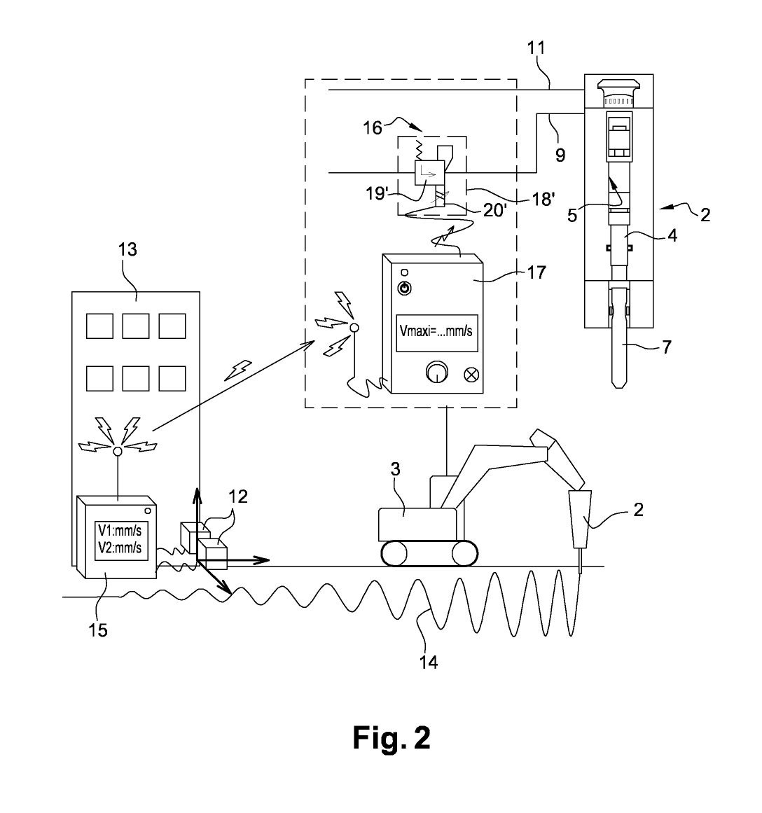

FIG. 2 represents an assembly according to a second embodiment of the disclosure which differs from the assembly on FIG. 1 essentially in that the control device 16 is formed by a proportional solenoid valve 18′ mounted on the high pressure supply circuit 9, and arranged for adjusting the operating pressure of the percussion apparatus 2 between a minimum operating pressure and a maximum operating pressure.

The proportional solenoid valve 18′ comprises a control member 19′ displaceable between a first control position corresponding to maximum impact energy of the striking piston 4 and a second control position corresponding to minimum impact energy of the striking piston 4. The proportional solenoid valve 18′ further comprises an actuating spool 20′ arranged for receiving the control instruction coming from the controller 17, and for displacing the control member 19′ between the first and second control positions thereof according to the received control instruction.

According to this embodiment of the disclosure, the controller 17 is arranged for:
correcting the control instruction of the control device 16 such as to decrease the operating pressure of the percussion apparatus 2 when the seismic data received by the controller 17 are higher than the predetermined threshold value, and
correcting the control instruction of the control device 16 such as to increase the operating pressure of the percussion apparatus 2 when the seismic data received by the controller 17 are lower than the predetermined threshold value.

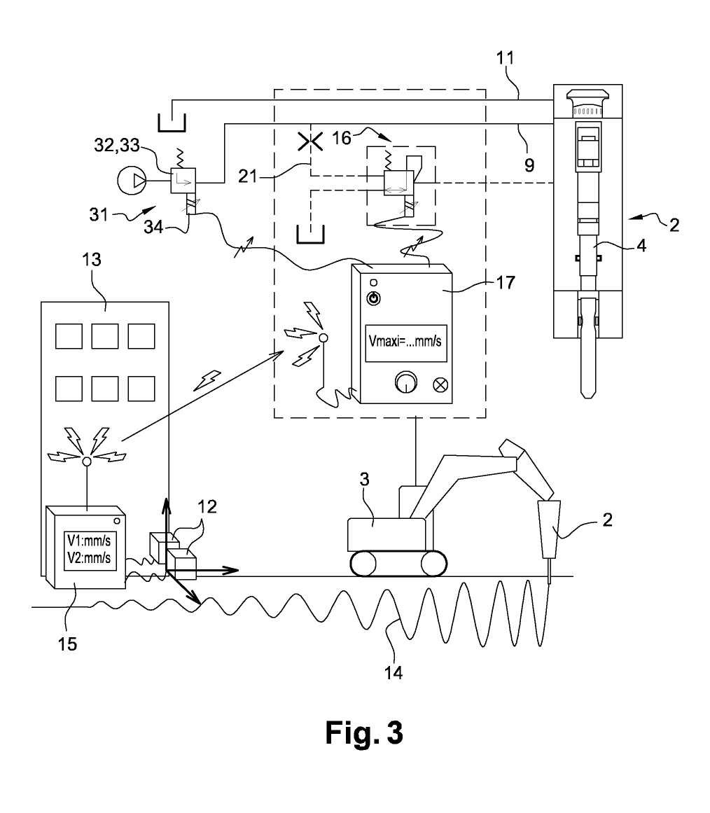

FIG. 3 represents an assembly according to a third embodiment of the disclosure which differs from the assembly represented on FIG. 1 essentially in that the controller 17 is arranged for controlling the interruption of the supply of the percussion apparatus with pressurized incompressible fluid when the seismic data received by the controller 17 are higher than the predetermined threshold value and when simultaneously the impact energy of the striking piston 4 is adjusted to a minimum by the control device 16.

According to the embodiment represented on FIG. 3, the assembly comprises a blocking device 31 mounted on the high pressure supply circuit 9, and arranged for blocking the high pressure supply circuit 9. The blocking device 31 is for example disposed upstream of the connecting point between the supply line 21 and the high pressure supply circuit 9.

The blocking device 31 is advantageously formed by a solenoid valve 32, and for example an on-off control solenoid valve, such as a normally open solenoid valve, or a normally closed solenoid valve.

The solenoid valve 32 advantageously comprises a blocking member 33 displaceable between a blocking position in which the blocking member 33 blocks the high pressure supply circuit 9, and a releasing position in which the blocking member 33 releases the high pressure supply circuit 9. The solenoid valve 32 further comprise an actuating spool 34 arranged for receiving a control instruction coming from the controller 17, and for displacing the blocking member 33 between the blocking and releasing positions thereof according to the received control instruction.

Thus, when the impact energy of the striking piston 4 is adjusted to its minimum by the control device 16, when simultaneously the seismic data received by the controller 17 are higher than the predetermined threshold value, the controller 17 applies a control instruction to the solenoid valve 32, and more particularly to the actuating spool 34 thereof such as to control a displacement of the blocking member 33 towards the blocking position thereof. These dispositions allow automatically interrupting the supply of pressurized incompressible fluid of the percussion apparatus 2, and hence protecting the structure 13 from the seismic waves generated by the percussion apparatus 2.

As it is known per se, the disclosure is not limited to the sole embodiments of this assembly, described hereinabove by way of examples, but encompasses all the variants.

1. A control method for controlling the impact energy of a striking piston of a percussion apparatus actuated by a pressurized incompressible fluid, the method including the following steps:
providing a control device arranged for adjusting the impact energy of the striking piston,
providing a controller arranged for applying a control instruction to the control device,
switching on the percussion apparatus,
measuring at least one seismic datum in the vicinity of a structure to be protected,
transmitting the at least one seismic datum measured to the controller,
comparing the at least one seismic datum received by the controller with a predetermined threshold value,
correcting the control instruction of the control device based on the at least one received seismic datum, and
applying, by means of the controller, said corrected control instruction to the control device.

2. The control method according to claim 1, wherein:
if the at least one received seismic datum is higher than the predetermined threshold value, the correcting step includes correcting the control instruction of the control device such as to reduce the impact energy of the striking piston.

3. The control method according to claim 1, wherein:
if the at least one seismic datum received is lower than the predetermined threshold value, the correcting step includes -correcting the control instruction of the control device such as to increase the impact energy of the striking piston.

4. The control method according to claim 1, which further includes the step of interrupting the supply of the percussion apparatus in pressurized incompressible fluid when the at least one seismic datum received by the controller is higher than the predetermined threshold value and when simultaneously the impact energy of the striking piston is adjusted to its minimum by the control device.

5. The control method according to claim 1, which further includes the step of displacing a control member included by the control device between a first control position corresponding to maximum impact energy of the striking piston and a second control position corresponding to a minimum impact energy of the striking piston.

6. An assembly comprising:
a percussion apparatus actuated by a pressurized incompressible fluid, including a striking piston arranged for hitting a tool during each operating cycle of the percussion apparatus,
a control device arranged for adjusting the impact energy of the striking piston,
a controller arranged for applying a control instruction to the control device,
seismic data measuring means intended to be disposed in the vicinity of a structure to be protected,
transmission means connected to the seismic data measuring means, and arranged for transmitting the seismic data measured by the measuring means,
the controller being arranged for:
receiving the seismic data transmitted by the transmission means,
comparing the received seismic data with a predetermined threshold value,
correcting the control instruction of the control device based on the received seismic data, and
applying said corrected control instruction to the control device.

7. The assembly according to claim 6, wherein, when the seismic data received by the controller are higher than the predetermined threshold value, the controller is arranged for correcting the control instruction of the control device such as to decrease the impact energy of the striking piston.

8. The assembly according to claim 6, wherein, when the seismic data received by the controller are lower than the predetermined threshold value, the controller is arranged for correcting the control instruction of the control device such as to increase the impact energy of the striking piston.

9. The assembly according to of claim 6, wherein the controller is arranged for controlling the interruption of the supply of the percussion apparatus in pressurized incompressible fluid when the seismic data received by the controller are higher than the predetermined threshold value and when simultaneously the impact energy of the striking piston is adjusted to its minimum by the control device.

10. The assembly according to claim 6, wherein the control device comprises a control member displaceable between a first control position corresponding to maximum impact energy of the striking piston and a second control position corresponding to a minimum impact energy of the striking piston.

11. The assembly according to claim 6, wherein the control device is arranged for adjusting the striking stroke of the striking piston between a short striking stroke and a long striking stroke.

12. The assembly according to claim 6, wherein the control device is arranged for adjusting the operating pressure of the percussion apparatus between a minimum operating pressure and a maximum operating pressure.
